(19) United States
(12) Patent Application Publication
(10) Pub. No.: US 2010/0095874 A1
(43) Pub. Date: Apr. 22, 2010

(54) METHOD FOR MANUFACTURING MINERAL BUILDING MATERIALS VIA BINDING AGENT SUSPENSIONS

(76) Inventor: Thomas Sievers, Hamburg (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 12/531,015

(22) PCT Filed: Mar. 14, 2008
(86) PCT No.: PCT/DE2008/000441

§ 371 Date: Sep. 11, 2009

(30) Foreign Application Priority Data
Mar. 14, 2007 (DE) 10 2007 012 987.6

(51) Int. Cl. C04B 28/02; C04B 40/00

(52) U.S. Cl. 106/784; 106/816; 106/792

(57) ABSTRACT

The object of the invention is a method for the production of mineral materials using bonding agents suspended in water, wherein the water is exposed to electromagnetic fields, including magnetic fields and/or electrical fields, and the suspension is exposed to a suspension mixer.

The invention relates to a method for manufacturing mineral building materials using binding agents suspended in water to obtain a suspension, wherein the water is exposed to electromagnetic fields, and the suspension to a suspension mixer.

Numerous methods have already been proposed for manufacturing concrete materials. For example, DE 10354888 B4 discloses that special suspension mixers can be used for the colloidal solubilization of binding agents, e.g., cement and fly ash. The binding agents are incorporated in water in the suspension mixer, and mixed using high shearing and cavitation forces.

It is known that magnetic fields and electrical fields can influence the inner consistency of water. Water processed in this way exhibits altered properties relative to density, viscosity, surface tension and electrical conductivity, among others.

There are numerical data to suggest that roughly 1% of the power generated worldwide is used for breaking and milling cement. This astonishing figure underscores the need to monitor the production process during the manufacture of concrete, and preclude unnecessary power consumption. Milling processes are power-intensive because only a small portion of the power introduced during milling is used for actual extremely fine milling, while the larger portion is unnecessarily released as heat and noise. Both burden the environment.

Various cement qualities can be produced out of the same clinker by varying the particle size. For example, rapidly curing cements with a faster hydration and strength development are manufactured by milling them more finely.

The object of the present invention is to condition and suspend binding agents in such a way as to reduce the incorporation of normally required further additives, and improve the flow characteristics of the binding agent glue and uncured mineral building material. Mineral building materials fabricated according to the invention exhibit a higher strength.

The present object is achieved according to the invention via a method based on the independent claim 1. Preferred embodiments are the topic of the subclaims or described below.

It was surprisingly found that improved binding agent glue can be obtained by subjecting water to magnetic fields and/or electrical fields (together referred to as electromagnetic fields), and adding binding agents to the latter thereafter or beforehand, preferably thereafter, and relaying the mixture to a suspension mixer. The binding agent exhibits improved flow characteristics and processability. In addition, the level of water consumption can be distinctly reduced.

The binding agent necessarily exhibits cement, gypsum and/or burnt lime, preferably at least cement.

In the sense linguistically used in this application, “gypsum” refers to the naturally occurring gypsum rock, the corresponding products from industrial processes (including anhydrite), as well as the products that arise when these parent substances are burned.

In terms of this invention, “cement” refers to an inorganic, finely milled material, which independently solidifies and hardens after mixed with water due to reactions with the mixing water, and remains solid and volumetrically stable after hardening, even underwater. From a chemical standpoint, it consists primarily of siliceous calcium with portions of aluminum and iron compounds, which is present as a complicated mixture of substances.

In addition to the above constituents, the binding agents can further contain fly ash and silica fume.

The so-called Blaine value is a standardized measure for how finely cement has been ground. It is indicated as the specific surface (cm²/g) ascertained with the Blaine apparatus. Standard Portland cement Pz 32.5 has a Blaine value of roughly 3,000 to 3,500. The Blaine value has a special influence on the early strength that can be achieved with the cement, and on the water consumption. The more finely the cement is ground, the higher its water consumption, and the higher the load that can be placed on it after a short time.

If the objective is to grind cement to values significantly higher than 3,500 Blaine, there is a disproportionate rise in the requirements on the mills used and the separation technique. Cements Pz 42.5 or Pz 52.5 having a high early strength and Blaine values of 4,000 to 5,500 cost significantly more to manufacture than “normal” Pz 32.5 owing to the high mechanical and power outlay required for their production. In isolated cases, cements with Blaine values of up to 8,000 were generated with an extremely high outlay.

The method according to the invention is able to increase the Blaine value of the used cement by at least 10% as the result of the treatment.

Additives that can be mixed in with the water include plasticizers, inhibitors, solidification accelerators, hardening accelerators, solvents, air pore formers, sealants and/or stabilizers.

The list also includes, classified by group, lignin sulfonates (also lignosulfonic acid), melamine-formaldehyde-sulfonates, naphthalene-formaldehyde-sulfonates, hydroxyl-carbonic acids and their salts (plasticizers); tensides, such as surfactants based on modified natural products like root resinates (air pore formers), as well as other emulsions of reactive siloxanes/alkyl alkoxysilanes, fatty acids, fatty acid salts, polycarboxylates, polymers (artificial resin dispersions), coloring pigments and mixtures thereof.

Additives can also include soluble salts like sodium chloride, sodium hydroxide and/or calcium hydroxide, for example in quantities of 0.01% w/w to 5% w/w, in particular 0.5% w/w to 2.5% w/w, relative to the used amount of water (=100% w/w).

Preferable mention is made of aggregates, such as solid rock, crushed stone, stone chips, artificial sand (crushed), gravel, sand or even blast furnace slag (not crushed), slag sand, coal fly ash, asphalt granules (also reclaimed asphalt) and demolished concrete, as well as mixtures thereof. The list also includes lightweight aggregates, such as fibers, expanded polystyrene, expanded clay, milled reclaimed rubber, mixed if necessary.

It was determined that sand-oriented concrete could be manufactured without diminishing strength, since the method according to the invention makes it possible to no longer use or to economize on so-called milled particles (coarse gravel, grain size exceeding 3 mm, e.g., 3 to 16 mm), and the concretes exhibited significantly better pumping characteristics due to the absence or strongly diminished portion of coarse particles.

It was further determined that concrete mixtures manufactured in this way are significantly more homogenous, and no “excess water” comes about either. The above features make it possible to achieve enormous potential savings and product improvements during the manufacture of concrete.

The water is conditioned through exposure to electromagnetic fields. The electromagnetic fields are generated by an alternating voltage with pulse amplitudes of 5 to 50 VSS, preferably 10 to 20 VSS, wherein the alternating voltage is preferably trapezoidal (constant voltage peaks for short intervals of time within each oscillation period). Suitable alternating voltage frequencies measure between 100 and 100,000 Hz, preferably 3,000 to 10,000 Hz. The electromagnetic fields are preferably introduced by way of coils wound around tubular containers, wherein the tubular container holds the water. Conditioning can take place in flow apparatuses. The flow rate can range from 0.1 m/s to 50 m/s, in particular from 2 m/s to 20 m/s. The alternating electromagnetic fields temporarily alter the structure of the water. This leads to changed “aqueous conditions” at the interfaces between the respective solids and the water. Also suitable for generating electromagnetic fields are permanent magnets, especially those with magnetic field strengths of 0.0001 to 2 Tesla, in particular from 0.2 to 1.2 Tesla.

The suspension mixer homogenizes the materials being mixed, and simultaneously acts to comminute the particles contained in the materials being mixed. The comminuting effect is similar to that exerted by a wet mill. Suitable suspension mixers include colloidal mixers or colloids dispersers.

To this end, the suspension mixer preferably exhibits two chambers (a pre-mixing zone and dispersing zone). The materials being mixed are passively moved in the pre-mixing zone through the outlet of the liquid materials being mixed via a separating element, wherein the materials being mixed are initially aspirated into the dispersing zone via a larger inlet in the separating element, preferably arranged over the rotational axis. The materials being mixed are there entrained by a high-speed agitator, and pressed radially outward, preferably upward, wherein the materials being mixed here passes in the direction of flow through smaller openings in the separating plate, or through smaller openings between the outer edge of the separating plate and container wall. The smaller openings are arranged on the outer periphery of the separating plate. Smaller and larger here denote the relative surface ratio between the smaller outlet openings to the larger inlet openings in the dispersing zone.

The high-speed agitator preferably exhibits agitator speeds of over 300 RPM, in particular 800 to 2,000 RPM. A circumferential speed of the agitator suitably ranges from 3 to 20 m/s, preferably from 12 to 17 m/s.

DE 103 54 888 B4 discloses one especially suitable suspension mixer. In this regard, reference is made to the disclosure and definition of the suspension mixer there, and in particular the definition according to claim 1, and hence also to the subject matter of the present application.

It is especially preferred that the mixing process take place in two different process zones (pre-mixing zone and dispersing zone). The continuous exchange of materials between the two zones yields the highest possible homogeneity of the materials being mixed. The mixing instrument rotating in the dispersing zone at a high circumferential speed (up to 2,000 RPM) simultaneously generates very high shearing and cavitation forces, which lead to an optimal, colloidal solubilization of the suspension. This results in the crucial advantages, such as greatest possible homogeneity of the mixture, minimal sedimentation of the mixture, constant rheology of the product, no subsequent swelling of the suspension, and lowest possible use of raw materials. Low to high-viscous systems can be processed, given a high mixing power and short mixing times. While a first process zone is set up for pre-mixing the mixture, the actual dispersal of the mixture takes place in the second process zone. The disclosure in DE 103 54 888 B4 is hereby also included as the subject matter of the present invention by reference.

If desired, the composition in the suspension mixer can (additionally, if needed) be exposed to an electromagnetic field, also encompassing a magnetic field as exerted by the above permanent magnets, and/or (additionally) ultrasound (frequency 20 kHz and 1 GHz).

Treating a liquid with ultrasound can give rise to sonochemical reactions. The reaction mechanisms during the breakdown of substances present in liquids are enabled by cavitation, and depend on the one hand from the ultrasound frequency, and on the other on the respective physicochemical properties of the substances. High shearing forces also arise in particular in the low-frequency range.

1. A method for manufacturing mineral building materials, comprising the following steps:
providing water;
providing binding agent, comprising at least cement with average particle sizes of 50 to 300 μm and/or gypsum and/or burnt lime and optionally additives;
exposing water to an electromagnetic field comprising a magnetic field and/or an electrical field in the presence or absence of the binding agent and the optional additive;
exposing the treated water containing binding agent and, if any, additive to a suspension mixer being selected from the group of colloidal mixers or colloidal dispersers for generating a suspension by mixing and comminuting the particles, comprising at least one dispersed, solid phase containing at least one portion of the binding agent and a continuous liquid phase comprising water; and
incorporating aggregates comprising at least sand and/or gravel into the suspension, optionally together with other substances, for generating the mineral building materials.

2. The method according to claim 1, wherein the comminuting increases at least the percent by weight of particles in suspension with diameters of under 0.1 μm by at least 5% w/w.

3. The method according to claim 1, wherein the suspension comprises 0.25 to 0.6 parts by weigh of water per part of binding agent after leaving the suspension mixer.

4. The method according to claim 1, wherein the mineral building material is one or more selected from the group consisting of: pre-cast concrete members, ready-mixed concrete, pumping concrete, prefabricated concrete, concrete pipes, concrete paving stones, concrete composite stones, concrete slabs, air-placed concrete in wet and dry processes, and lightweight concrete.

5. The method according to claim 1, wherein the water exposed to the electromagnetic field, comprising magnetic field and/or electrical field, is directly introduced into the suspension mixer the water in the suspension mixer is exposed to the electromagnetic field or both.

6. The method according to claim 1, wherein the suspension mixer comprises a rotor and stator, and the rotor speed preferably exceeds 300 RPM.

7. The method according to claim 1, wherein the suspension mixer comprises a passively moved pre-mixing zone and an actively agitated dispersing zone, wherein the dispersing zone and pre-mixing zone are separated by a separating element provided with holes, while the dispersing zone and pre-mixing zone are in fluidic communication, and the dispersing zone contains an agitator.

8. The method according to claim 7, wherein the separating element exhibits multiple smaller openings on the outer periphery as outlet openings from the dispersing zone, and centrally at least one larger opening as the inlet opening into the dispersing zone, wherein the larger opening is larger in area than the respective smaller openings by a factor of at least 5.

9. The method according to claim 8, wherein an electromagnetic field comprising magnetic fields and/or electrical fields acts on the materials being mixed in the area of the inlet opening.

10. The method according to claim 7, wherein the agitator moves at an agitating speed exceeding 300 RPM.

11. The method according to claim 7, wherein the agitator exhibits a circumferential speed of between 3 and 20 m/s.

12. The method according to claim 1, wherein the used binding agent exhibits average particle sizes of 50 to 300 μm.

13. The method according to claim 1, wherein the used binding agent exhibits Blaine values of 3,000 to 8,000 cm²/g.

14. The method according to claim 1, wherein the portion of binding agent in the mineral building material measures 6 to 35% w/w after hardening.

15. The method according to claim 1, wherein the portion of additive measures 0.2 to 8% w/w relative to the weight of the used binding agent.

16. The method according to claim 1, wherein the electromagnetic fields are alternating electromagnetic fields, and generated via alternating voltage with pulse amplitudes of 5 to 50 V_{SS}.

17. The method according to claim 1, wherein the electromagnetic fields are generated via electrical alternating voltage with frequencies of between 100 and 100,000 Hz.

18. The method according to claim 1, wherein the electromagnetic fields are generated by a coil that surrounds the walls of a flow or storage container.

19. The method according to claim 1, wherein the water is exposed to the electromagnetic field in a flow apparatus.

20. The method according to claim 1, wherein the electromagnetic fields are generated by a wobbled voltage, optionally in the form of a saw tooth signal.

21. The method according to claim 1, wherein the water has a pH value of 7 or below.

22. The method according to claim 1, wherein the electromagnetic fields are obtainable by a permanent magnet.

23. The method according to claim 1, wherein the aggregates mixed with water are/were exposed to the electromagnetic field, and are subsequently added.

24. The method according to claim 3, wherein the suspension comprises 0.28 to 0.4 parts by weight of water, per part of binding agent after leaving the suspension mixer.

25. The method according to claim 6, wherein the rotor speed exceeds 1,000 RPM.

26. The method according to claim 8, wherein the larger opening is larger in area than the respective smaller openings by a factor of at least 10.

27. The method according to claim 7, wherein the agitator moves at an agitating speed ranging from 800 to 2,000 RPM.

28. The method according to claim 7, wherein the agitator exhibits a circumferential speed of between 12 and 17 m/s.

29. The method according to claim 1, wherein the used binding agent exhibits average particle sizes of 50 to 300 μm, wherein less than 5% v/v of the particles exhibit particle sizes of less than 20 μm, and less than 5% w/w exhibit particle sizes of greater than 300 μm.

30. The method according to claim 16, wherein the electromagnetic fields are alternating electromagnetic fields, generated via alternating voltage with pulse amplitudes of 10 to 20 V_{SS}.

31. The method according to claim 16, wherein the alternating voltage is trapezoidal.

32. The method according to claim 17, wherein, the electromagnetic fields are generated via electrical alternating voltage with frequencies of between 3,000 and 10,000 Hz.

33. The method according to claim 22, wherein the electromagnetic fields are obtainable by a permanent magnet with a magnetic field strengths of 0.0001 to 2 Tesla.

34. The method according to claim 22, wherein the electromagnetic fields are obtainable by a permanent magnet with a magnetic field strengths of 0.2 to 1.2 Tesla.
